(19) United States
(12) Patent Application Publication
(10) Pub. No.: US 2023/0384657 A1
(43) Pub. Date: Nov. 30, 2023

(54) PROJECTION DEVICE AND CASING STRUCTURE

(71) Applicant: Coretronic Corporation, Hsin-chu (TW)

(72) Inventors: Yu-Wei Guo, Hsin-Chu (TW); Chang-Yung Chen, Hsin-Chu (TW)

(73) Assignee: Coretronic Corporation, Hsin-Chu (TW)

(21) Appl. No.: 17/894,162

(22) Filed: Aug. 24, 2022

Related U.S. Application Data
(60) Provisional application No. 63/345,449, filed on May 25, 2022.

(51) Int. Cl. G03B 21/16; G03B 21/14

(52) U.S. Cl. CPC G03B 21/16; G03B 21/145

(57) ABSTRACT

The disclosure provides a projection device including a casing structure, a light source, a light valve element and a projection lens. The casing structure includes a main casing and at least one shielding structure. The main casing has an inner space and at least one heat dissipation opening, and the at least one shielding structure is connected to an inner surface of the main casing to be located in the inner space. The light source is disposed in an arrangement region of the inner space for providing an illumination beam. The light valve element is disposed in the arrangement region for converting the illumination beam into an image beam. The projection lens is disposed in the arrangement region for projecting the image beam. The shielding structure shades the at least one heat dissipation opening, such that the arrangement region is invisible from outside of the main casing.

### CROSS-REFERENCE TO RELATED APPLICATION

This application claims the priority benefit of U.S. provisional application Ser. No. 63/345,449, filed on May 25, 2022. The entirety of the above-mentioned patent application is hereby incorporated by reference herein and made a part of this specification.

### BACKGROUND

### Technical Field

The disclosure relates to an optical device and a casing structure, and more particularly, to a projection device and a casing structure thereof.

### Description of Related Art

A projection device is a display device for generating a large-sized image. The imaging principle of a projection device is to convert an illumination beam generated by a light source into an image beam via a light valve, and then to project the image beam onto a screen or a wall through a projection lens so as to form an image. With advancement in projection techniques and reduction in manufacturing cost of projection devices, applications of projection devices have been gradually expanded from commercial use to household use. Main components of a projection device include a light source, a light valve, and a projection lens. An illumination beam generated by a light source is converted into an image beam via a light valve, and then the image beam is projected via a projection lens. Due to the projection device projecting the image beam, heat may be generated by at least one of light sources and at least one of light valves in the projection device. Therefore, it is a challenge how to effectively dissipate the heat of the projection device.

In order to allow a heat dissipation airflow to flow into and out of the projection device, heat dissipation openings are formed on a casing of the projection device. Inner structures and/or inner components of the projection device can be seen by an observer through the heat dissipation openings, which affects the appearance of the projection device. Meanwhile, the light beams generated by the light source maybe directly emit to eyes of the observer through the heat dissipation openings, such that the eyes of the observer hurt. It is a big security issue. In some projection devices, the heat dissipation openings are formed on the casing with small opening ratio for solving the above-mentioned problem. However, the heat dissipation efficiency of the projection device is reduced due to the small opening ratio of the heat dissipation openings. In addition, in some projection devices, the heat dissipation openings are formed on the casing with inclined angle for solving the above-mentioned problem. However, the heat dissipation openings with inclined angle provide visual shading merely in a specific view angle but not provide complete visual shading.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device and a casing structure thereof, which prevents inner structures and/or inner components from being seen through heat dissipation openings while provides good heat dissipation efficiency.

Other objectives and advantages of the disclosure may be further understood from the technical features disclosed in the disclosure.

In order to achieve one or part or all of the above objectives or other objectives, an embodiment of the disclosure provides a projection device including a casing structure, a light source, a light valve element and a projection lens. The casing structure includes a main casing and at least one shielding structure. The main casing has an inner space and at least one heat dissipation opening, and the at least one shielding structure is connected to an inner surface of the main casing to be located in the inner space. The light source is disposed in an arrangement region of the inner space and adapted to provide an illumination beam. The light valve element is disposed in the arrangement region and adapted to convert the illumination beam into an image beam. The projection lens is disposed in the arrangement region and adapted to project the image beam. The at least one shielding structure shades the at least one heat dissipation opening, such that the arrangement region is invisible from outside of the main casing.

In order to achieve one or part or all of the above objectives or other objectives, an embodiment of the disclosure provides a casing structure including a main casing and at least one shielding structure. The main casing has an inner space and at least one heat dissipation opening. The at least one shielding structure is connected to an inner surface of the main casing to be located in the inner space. The at least one shielding structure shades the at least one heat dissipation opening, such that the arrangement region is invisible from outside of the main casing.

In an embodiment of the disclosure, the main casing includes a first wall and a second wall, the first wall extends along a first direction, the second wall extends along a second direction perpendicular to the first direction, and the at least one heat dissipation opening is formed between the first wall and the second wall.

In an embodiment of the disclosure, the at least one shielding structure is connected to the first wall and extends along the second direction.

In an embodiment of the disclosure, a width of an orthogonal projection of the second wall on the first wall along the first direction is a, a width of the at least one heat dissipation opening along the second direction is b, a shortest distance, along the first direction, between an end of the first wall adjacent to the at least one heat dissipation opening and a surface of the at least one shielding structure facing the at least one heat dissipation opening is h, a length of the at least one shielding structure along the second direction is w, and w is equal to or greater than h*(b/a).

In an embodiment of the disclosure, the at least one shielding structure includes a first shielding structure and a second shielding structure, the first shielding structure is connected to the first wall and extends along the second direction, and the second shielding structure is connected to the second wall and extends along a direction opposite to the first direction.

In an embodiment of the disclosure, a width of an orthogonal projection of the second wall on the first wall along the first direction is a, a width of the at least one heat dissipation opening along the second direction is b, a distance between the first shielding structure and an end of the first wall adjacent to the at least one heat dissipation opening along the first direction is h, a distance between the second shielding structure and the at least one heat dissipation opening along the second direction is h′, a length of the first shielding structure along the second direction is w, a length of the second shielding structure along the first direction is w′, w′ is equal to or greater than h′*(a/b), and w is equal to or greater than h*((b+h′)/(a+w′)).

In an embodiment of the disclosure, the main casing includes a first casing and a second casing assembled to each other, the at least one heat dissipation opening is a gap between the first casing and the second casing, and the at least one shielding structure is formed on the first casing or the second casing.

In an embodiment of the disclosure, the main casing includes a first casing and a second casing assembled to each other, and the at least one heat dissipation opening and the at least one shielding structure are formed on the first casing.

In an embodiment of the disclosure, the at least one shielding structure is at least one rib integrally formed on the main casing.

In an embodiment of the disclosure, the at least one heat dissipation opening is an air outlet or an air inlet.

Based on the above, the embodiments of the disclosure have at least one of the following advantages or effects. In the projection device of the embodiments of the disclosure, the shielding structure shades the heat dissipation opening, such that inner structures and/or inner components of the projection device are prevented from being seen through the heat dissipation opening. Accordingly, it is no need to reduce the opening ratio of the heat dissipation opening for the above-mentioned purpose, and thus good heat dissipation efficiency of the projection device can be maintained.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2 is a perspective view of the projection device of FIG. 1.

FIG. 3 is a schematic cross-sectional view of parts of components of the projection device along line I-I of FIG. 2.

FIG. 4 is a cross-sectional view of a detail partial area of the projection device along line I-I of FIG. 2.

FIG. 5 is a schematic cross-sectional view of partial area of the projection device of FIG. 3.

FIG. 6 is a schematic cross-sectional view of partial area of the projection device according to another embodiment.

FIG. 7 is a schematic cross-sectional view of partial area of the projection device according to another embodiment.

FIG. 8 is a schematic cross-sectional view of partial area of the projection device according to another embodiment.

FIG. 9 is a schematic cross-sectional view of partial area of the projection device according to another embodiment.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

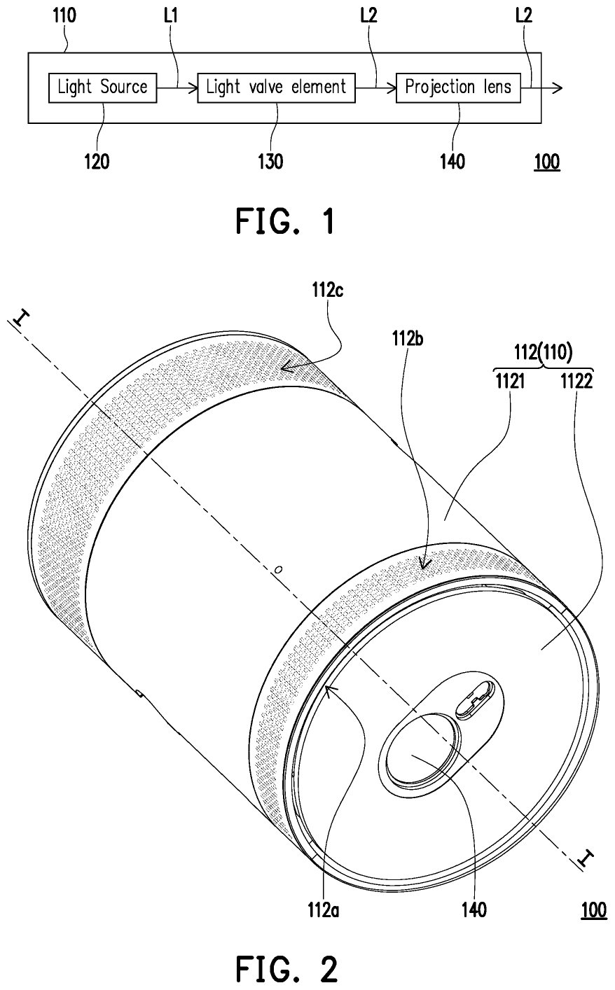

FIG. 1 is a schematic view of a projection device according to an embodiment of the disclosure. Please refer to FIG. 1. A projection device 100 (projector) of this embodiment includes a casing structure 110, a light source 120, a light valve element 130 and a projection lens 140. The light source 120 is disposed in the casing structure 110 and adapted for providing an illumination beam L1. The light valve module 130 is disposed in the casing structure 110 to be located on a transmission path of the illumination beam L1, and is adapted for converting the illumination beam L1 into an image beam L2. The projection lens 140 is disposed in the casing structure 110 to be located on a transmission path of the image beam L2, and is adapted for projecting the image beam L2. The light source 120 may comprise at least one light-emitting diode (LED) element or at least one laser diode (LD). The light source 120 emits the illumination light beam L1 comprising at least one color light beam. For example, at least one color light beam may be red, green and blue light beams. The light valve module 130 comprises a spatial light modulator. The spatial light modulator is such as a digital micro-mirror element (DMD), a liquid-crystal-on-silicon Panel (LCOS panel), or a liquid crystal panel (LCD). In addition, the projection lens 140 is, for example, a combination of one or more optical lenses with a diopter range. The one or more optical lenses include, for example, various combinations of non-planar lenses such as a double-concave lens, a double-convex lens, a concavo-convex lens, a convexo-concave lens, a plano-convex lens, and a plano-concave lens.

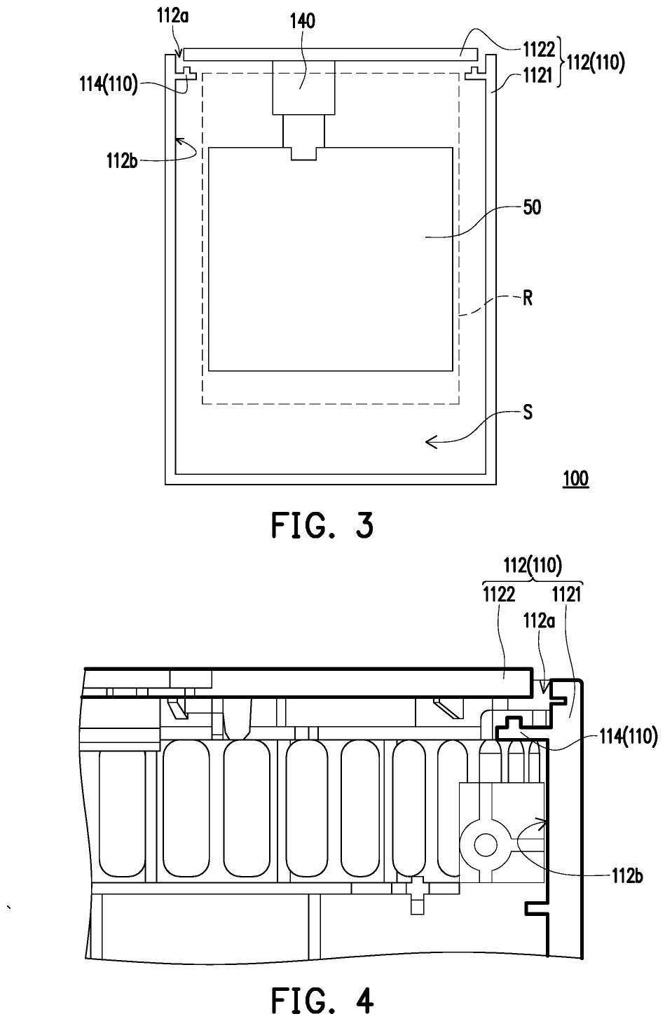

FIG. 2 is a perspective view of the projection device of FIG. 1. FIG. 3 is a schematic cross-sectional view of parts of components of the projection device along line I-I of FIG. 2. Please refer to FIG. 2 and FIG. 3. The casing structure 110 includes a main casing 112, and the main casing 112 includes a first casing 1121 and a second casing 1122 assembled to each other. The first casing 1121 is, for example, a cylindrical casing. The second casing 1122 is, for example, an end cover assembled to the cylindrical casing, and the disclosure is not limited thereto. The second casing 1122 has a surface and an opening. A direction of the image beam L2 projected by the projection lens 140, via the opening, is parallel to a normal direction of the surface. The main casing 112 has an inner space S. The projection lens 140 and an optical engine 50 including the light source 120 and the light valve element 130 are disposed in an arrangement region R of the inner space S.

The main casing 112 has at least one heat dissipation opening (illustrated as a ring-shaped heat dissipation opening 112a surrounding the second casing 1122, front heat dissipation openings 112b and rear heat dissipation openings 112c). The front heat dissipation openings 112b are closer to the second casing 1122 than the rear heat dissipation openings 112c. The heat dissipation opening 112a is a gap between the first casing 1121 and the second casing 1122, and the front heat dissipation openings 112b and the rear heat dissipation openings 112c are formed on the first casing 1121. Specifically, the heat dissipation opening 112a and the front heat dissipation openings 112b are air inlets and the rear heat dissipation openings 112c are air outlets, and the disclosure is not limited thereto. A heat dissipation fan or other types of airflow generating unit may be disposed inside the main casing 112 to provide an airflow flowing through the above-mentioned air inlets and air outlets, and the disclosure is not limited thereto.

FIG. 4 is a cross-sectional view of a detail partial area of the projection device along line I-I of FIG. 2. Please refer to FIG. 3 and FIG. 4. The casing structure 110 of the embodiment further includes a shielding structure 114, which is connected to an inner surface 112b of the first casing 1121 of the main casing 112 to be located in the inner space S. The shielding structure 114 blocks the heat dissipation opening 112a, such that the arrangement region R is invisible from outside of the main casing 110 through the heat dissipation opening 112a. A size of the shielding structure 114 is larger than a size of the heat dissipation opening 112a. Accordingly, inner structures and/or inner components (e.g. a stray light emitted from the optical engine 50 including the light source 120 and the light valve element 130 or the like) of the projection device 100 are prevented from being seen through the heat dissipation opening 112a. Therefore, it is no need to reduce the opening ratio of the heat dissipation opening 112a for the above-mentioned purpose, and thus good heat dissipation efficiency of the projection device 100 can be maintained.

In the embodiment, the shielding structure 114 includes one or more ribs integrally formed on the main casing 110 and corresponding to the heat dissipation opening 112a. In other embodiments, the shielding structure 114 may be other types of structure and may be corresponding to the front heat dissipation openings 112b (or the rear heat dissipation openings 112c) to shade the front heat dissipation openings 112b (or the rear heat dissipation openings 112c), and the disclosure is not limited thereto.

An example of the specific location and length of the shielding structure 114 will be described below.

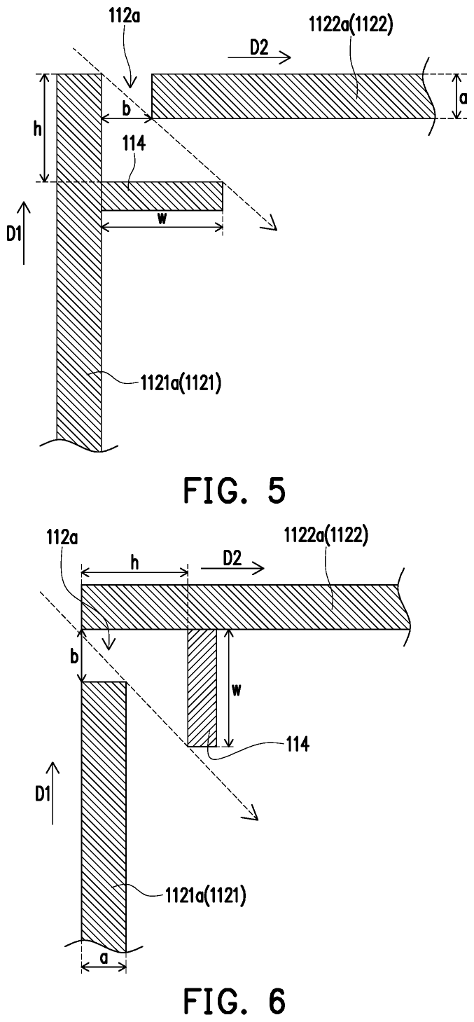

FIG. 5 is a schematic cross-sectional view of partial area of the projection device of FIG. 3. Please refer to FIG. 5, the first casing 1121 includes a first wall 1121a, and the second casing 1122 includes a second wall 1122a. The first wall 1121a extends along a first direction D1, the second wall 1122a extends along a second direction D2. The second direction D2 is perpendicular to the first direction D1. The heat dissipation opening 112a is formed between the first wall 1121a and the second wall 1122a. The shielding structure 114 is connected to the first wall 1121a and extends along the second direction D2. A width of the second wall 1122a along the first direction D1 is a. In detailed, a width of an orthogonal projection of the second wall 1122a on the first wall 1121a along the first direction D1 is a. A shortest distance, along the first direction D1, between an end of the first wall 1121a adjacent to the heat dissipation opening 112a and a surface of the shielding structure 114 facing the heat dissipation opening 112a is h. A width of the heat dissipation opening 112a along the second direction D2 is b, and a length of the shielding structure 114 along the second direction D2 is w. The length w of the shielding structure 114 is equal to or greater than h*(b/a), such that the arrangement region R (labeled in FIG. 3) inside the main casing 110 is invisible from outside of the main casing 110 by shading of the shielding structure 114.

FIG. 6 is a schematic cross-sectional view of partial area of the projection device according to another embodiment. The main difference between the embodiments of FIG. 5 and FIG. 6 is that, the shielding structure 114 in FIG. 6 is connected to the second wall 1122a of the second casing 1122. Specifically, in FIG. 6, the shielding structure 114 connected to the second wall 1122a extends along a direction opposite to the first direction D1. A width of the first wall 1121a along the second direction D2 is a. In detailed, a width of an orthogonal projection of the first wall 1121a on the second wall 1122a along the second direction D2 is a. A shortest distance, along the second direction D2, between an end of the second wall 1122a adjacent to the heat dissipation opening 112a and a surface of the shielding structure 114 facing the heat dissipation opening 112a is h. A width of the heat dissipation opening 112a along the first direction D1 is b, and a length of the shielding structure 114 along the first direction D1 is w. The length w of the shielding structure 114 is equal to or greater than h*(b/a), such that the arrangement region R inside the main casing 112 is invisible from outside of the main casing 112 by shading of the shielding structure 114.

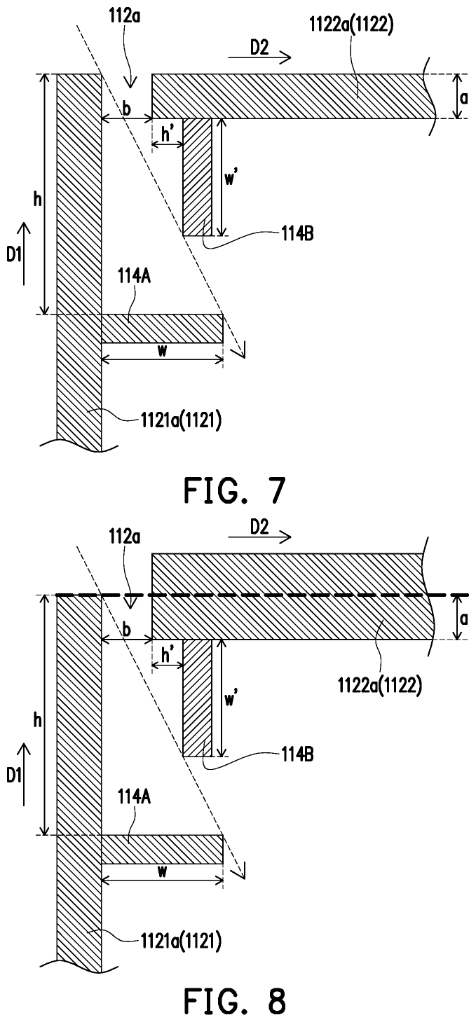

FIG. 7 is a schematic cross-sectional view of partial area of the projection device according to another embodiment. The main difference between the embodiments of FIG. 5 and FIG. 7 is that, a first shielding structure 114A and a second shielding structure 114B are arranged in the main casing 112. Specifically, in FIG. 7, the first shielding structure 114A is connected to the first wall 1121a and extends along the second direction D2, and the second shielding structure 114B is connected to the second wall 1122a and extends along a direction opposite to the first direction D1. A width of an orthogonal projection of the second wall 1122a on the first wall 1121a along the first direction D1 is a, a width of the heat dissipation opening 112a along the second direction D2 is b, a shortest distance between a surface of the first shielding structure 114A facing the heat dissipation opening 112a and an end of the first wall 1121a adjacent to the heat dissipation opening 112a along the first direction D1 is h, a shortest distance between a surface of the second shielding structure 114B facing the heat dissipation opening 112a and the heat dissipation opening 112a along the second direction D2 is h′, a length of the first shielding structure 114A along the second direction D2 is w, and a length of the second shielding structure 114B along the first direction D1 is w′. In a condition that the length w′ of the second shielding structure 114B is equal to or greater than h′*(a/b), as long as the length w of the first shielding structure 114A is equal to or greater than h*((b+h′)/(a+w′)), the arrangement region R inside the main casing 112 is invisible from outside of the main casing 112 by shading of the first shielding structure 114A and the first shielding structure 114B.

In the embodiment of FIG. 7, if the length w′ of the second shielding structure 114B along the first direction D1 is less than h′*(a/b), then the second shielding structure 114B does not completely shade the heat dissipation opening 112a, such that the arrangement region R inside the main casing 112 are visible through the heat dissipation opening 112a. In this condition, the length w of the first shielding structure 114A along the second direction D2 may be equal to or greater than h*(b/a) for providing shading the heat dissipation opening 112a.

FIG. 8 is a schematic cross-sectional view of partial area of the projection device according to another embodiment. The main difference between the embodiments of FIG. 7 and FIG. 8 is that, the width a of the orthogonal projection of the second wall 1122a on the first wall 1121a along the first direction D1 in FIG. 7 is equal to the thickness of the second wall 1122a, while the width a of the orthogonal projection of the second wall 1122a on the first wall 1121a along the first direction D1 in FIG. 8 is less than the thickness of the second wall 1122a. Other arrangements of the embodiment of FIG. 8 are the same as or similar to that of FIG. 7, and will not described repeatedly.

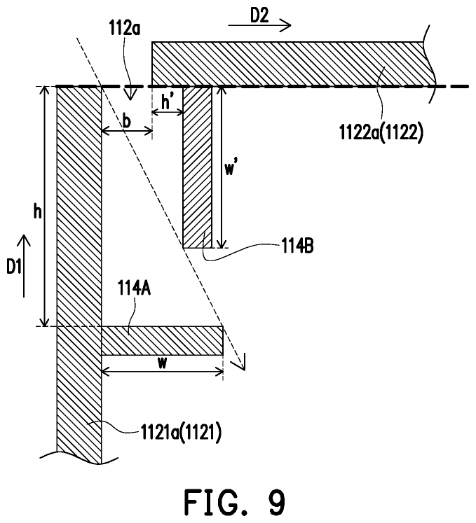

FIG. 9 is a schematic cross-sectional view of partial area of the projection device according to another embodiment. The main difference between the embodiments of FIG. 7 and FIG. 9 is that, the width a of the orthogonal projection of the second wall 1122a on the first wall 1121a along the first direction D1 in FIG. 7 is equal to the thickness of the second wall 1122a, while the width a of the orthogonal projection of the second wall 1122a on the first wall 1121a along the first direction D1 in FIG. 9 is zero. That is, in FIG. 9, the second wall 1122a does not overlap the first wall 1121a along the second direction D2, and thus the second wall 1122a has no orthogonal projection on the first wall 1121a. Other arrangements of the embodiment of FIG. 9 are the same as or similar to that of FIG. 7, and will not described repeatedly.

To sum up, the embodiments of the disclosure have at least one of the following advantages or effects. In the projection device of the embodiments of the disclosure, the shielding structure shades the heat dissipation opening, such that inner structures and/or inner components of the projection device are prevented from being seen through the heat dissipation opening. Accordingly, it is no need to reduce the opening ratio of the heat dissipation opening for the above-mentioned purpose, and thus good heat dissipation efficiency of the projection device can be maintained.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
a casing structure, comprising a main casing and at least one shielding structure, wherein the main casing has an inner space and at least one heat dissipation opening, and the at least one shielding structure is connected to an inner surface of the main casing to be located in the inner space;
a light source, disposed in an arrangement region of the inner space and adapted to provide an illumination beam;
a light valve element, disposed in the arrangement region and adapted to convert the illumination beam into an image beam; and
a projection lens, disposed in the arrangement region and adapted to project the image beam,
wherein the at least one shielding structure shades the at least one heat dissipation opening, such that the arrangement region is invisible from outside of the main casing.

2. The projection device according to claim 1, wherein the main casing comprises a first wall and a second wall, the first wall extends along a first direction, the second wall extends along a second direction perpendicular to the first direction, and the at least one heat dissipation opening is formed between the first wall and the second wall.

3. The projection device according to claim 2, wherein the at least one shielding structure is connected to the first wall and extends along the second direction.

4. The projection device according to claim 3, wherein a width of an orthogonal projection of the second wall on the first wall along the first direction is a, a width of the at least one heat dissipation opening along the second direction is b, a shortest distance, along the first direction, between an end of the first wall adjacent to the at least one heat dissipation opening and a surface of the at least one shielding structure facing the at least one heat dissipation opening is h, a length of the at least one shielding structure along the second direction is w, and w is equal to or greater than h*(b/a).

5. The projection device according to claim 2, wherein the at least one shielding structure comprises a first shielding structure and a second shielding structure, the first shielding structure is connected to the first wall and extends along the second direction, and the second shielding structure is connected to the second wall and extends along a direction opposite to the first direction.

6. The projection device according to claim 5, wherein a width of an orthogonal projection of the second wall on the first wall along the first direction is a, a width of the at least one heat dissipation opening along the second direction is b, a distance between the first shielding structure and an end of the first wall adjacent to the at least one heat dissipation opening along the first direction is h, a distance between the second shielding structure and the at least one heat dissipation opening along the second direction is h′, a length of the first shielding structure along the second direction is w, a length of the second shielding structure along the first direction is w′, w′ is equal to or greater than h′*(a/b), and w is equal to or greater than h*((b+h′)/(a+w′)).

7. The projection device according to claim 1, wherein the main casing comprises a first casing and a second casing assembled to each other, the at least one heat dissipation opening is a gap between the first casing and the second casing, and the at least one shielding structure is formed on the first casing or the second casing.

8. The projection device according to claim 1, wherein the main casing comprises a first casing and a second casing assembled to each other, and the at least one heat dissipation opening and the at least one shielding structure are formed on the first casing.

9. The projection device according to claim 1, wherein the at least one shielding structure is at least one rib integrally formed on the main casing.

10. The projection device according to claim 1, wherein the at least one heat dissipation opening is an air outlet or an air inlet.

11. A casing structure, comprising:
a main casing, having an inner space and at least one heat dissipation opening; and
at least one shielding structure, connected to an inner surface of the main casing to be located in the inner space,
wherein the at least one shielding structure shades the at least one heat dissipation opening, such that the arrangement region is invisible from outside of the main casing.

12. The casing structure according to claim 11, wherein the main casing comprises a first wall and a second wall, the first wall extends along a first direction, the second wall extends along a second direction perpendicular to the first direction, and the at least one heat dissipation opening is formed between the first wall and the second wall.

13. The casing structure according to claim 12, wherein the at least one shielding structure is connected to the first wall and extends along the second direction.

14. The casing structure according to claim 13, wherein a width of an orthogonal projection of the second wall on the first wall along the first direction is a, a width of the at least one heat dissipation opening along the second direction is b, a shortest distance, along the first direction, between an end of the first wall adjacent to the at least one heat dissipation opening and a surface of the at least one shielding structure facing the at least one heat dissipation opening is h, a length of the at least one shielding structure along the second direction is w, and w is equal to or greater than h*(b/a).

15. The casing structure according to claim 12, wherein the at least one shielding structure comprises a first shielding structure and a second shielding structure, the first shielding structure is connected to the first wall and extends along the second direction, the second shielding structure is connected to the second wall and extends along a direction opposite to the first direction.

16. The casing structure according to claim 15, wherein a width of an orthogonal projection of the second wall on the first wall along the first direction is a, a width of the at least one heat dissipation opening along the second direction is b, a distance between the first shielding structure and an end of the first wall adjacent to the at least one heat dissipation opening along the first direction is h, a distance between the second shielding structure and the at least one heat dissipation opening along the second direction is h′, a length of the first shielding structure along the second direction is w, a length of the second shielding structure along the first direction is w′, w′ is equal to or greater than h′*(a/b), and w is equal to or greater than h*((b+h′)/(a+w′)).

17. The casing structure according to claim 11, wherein the main casing comprises a first casing and a second casing assembled to each other, the at least one heat dissipation opening is a gap between the first casing and the second casing, and the at least one shielding structure is formed on the first casing or the second casing.

18. The casing structure according to claim 11, wherein the main casing comprises a first casing and a second casing assembled to each other, and the at least one heat dissipation opening and the at least one shielding structure are formed on the first casing.

19. The casing structure according to claim 11, wherein the at least one shielding structure is at least one rib integrally formed on the main casing.

20. The casing structure according to claim 11, wherein the at least one heat dissipation opening is an air outlet or an air inlet.
